(19) United States
(12) Patent Application Publication
(10) Pub. No.: US 2021/0324250 A1
(43) Pub. Date: Oct. 21, 2021

(54) ONE-PART THERMALLY CURABLE COMPOSITION

(71) Applicant: 3M INNOVATIVE PROPERTIES COMPANY, St. Paul, MN (US)

(72) Inventors: Kolby L. White, Woodbury, MN (US); Joseph D. Rule, Woodbury, MN (US); Matthew J. Kryger, Hudson, WI (US); Michael A. Kropp, Cottage Grove, MN (US)

(21) Appl. No.: 17/271,457

(22) PCT Filed: Sep. 18, 2019
(86) PCT No.: PCT/IB2019/057877

§ 371 Date: Feb. 25, 2021

Related U.S. Application Data
(60) Provisional application No. 62/736,273, filed on Sep. 25, 2018.

(51) Int. Cl. C09J 175/04; C09J 5/06; C08G 18/00; C08G 18/79; C08G 18/20; C08G 18/28; C08G 18/32; C08G 18/38; B32B 7/12

(52) U.S. Cl. CPC C09J 175/04; C09J 5/06; C08G 18/003; C08G 18/798; C08G 18/2063; C08G 18/2825; B32B 15/016; C08G 18/3876; B32B 7/12; C09J 2463/00; C08G 2170/20; C09J 2475/00; C08G 18/3206

(57) ABSTRACT

A one-part thermally curable composition comprises at least one polyuretdione, thermally activatable amine curative; optional epoxy resin; optional polythiol having an average sulfhydryl group functionality of at least 2; and optional acid stabilizer. The at least one polyuretdione has an average uretdione ring functionality of at least 1.2, and is a reaction product of components comprising: a uretdione-containing material comprising a reaction product of a diisocyanate reacted with itself; a first hydroxyl-containing compound having a single OH group, wherein the first hydroxyl-containing compound is a primary alcohol or a secondary alcohol; and a second hydroxyl-containing compound having more than one OH group, wherein the second hydroxyl-containing compound is a polyol and the reaction product comprises 0.2 to 0.5, inclusive, of hydroxyl equivalents relative to isocyanate equivalents. Cured compositions and assemblies including them are also disclosed.

### TECHNICAL FIELD

The present disclosure broadly relates to compositions that include uretdione rings and methods of making and using them.

### BACKGROUND

Two-part urethane adhesives, sealants and coatings are commercially available from 3M and other companies. These systems typically involve one component that is an isocyanate-terminated oligomer and a second component that is a polyol. When combined, the isocyanate reacts with the polyol to form carbamate groups. While this is established and effective chemistry, it suffers from a sensitivity to moisture and from various regulatory concerns.

It would be desirable to have alternatives to isocyanates for use in compositions such as adhesives and/or sealants that perform comparably to, or better than, the current isocyanate-based formulations in one or more applications. Further, it would be desirable to eliminate the need for mixing the two-parts of those curable compositions in the field.

### SUMMARY

The present disclosure provides one-part thermally curable compositions, cured compositions, and assemblies including them that may be useful for instance in coatings, sealants, and/or adhesives that may have good flowability and reactivity (e.g., without added solvent), acceptable cure and/or adhesion in a short amount of time, as compared to similar compositions containing isocyanates. Further, coatings, sealants, and adhesives according to at least certain embodiments of the present disclosure may be essentially free of isocyanates. This can be advantageous because isocyanates can be sensitizers upon first contact (e.g., to skin) such that subsequent contact causes inflammation. Further, coatings, sealants, and adhesives containing isocyanates exhibit more sensitivity to water than other compounds, as noted above, so minimizing an isocyanate content in a coating, sealant, or adhesive may improve reliability during curing as well as simplify storage and handling of the polymeric materials and polymerizable compositions.

In one aspect, the present disclosure provides a one-part thermally curable composition comprising:
at least one polyuretdione, the at least one polyuretdione having an average uretdione ring functionality of at least 1.2, wherein the at least one polyuretdione is a reaction product of components comprising:
   a) a uretdione-containing material comprising a reaction product of a diisocyanate reacted with itself,
   b) a first hydroxyl-containing compound having a single OH group, wherein the first hydroxyl-containing compound is a primary alcohol or a secondary alcohol; and
   c) a second hydroxyl-containing compound having more than one OH group, wherein the second hydroxyl-containing compound is a polyol and the reaction product comprises 0.2 to 0.5, inclusive, of hydroxyl equivalents relative to isocyanate equivalents;
thermally activatable amine curative;
optional epoxy resin;
optional polythiol having an average sulfhydryl group functionality of at least 2; and optional acid stabilizer.

The one-part thermally curable composition can be cured by heating, yet has a useful working-life (e.g., from several hours to several days at room temperature) before curing. Once prepared, it can be stored under refrigerated conditions until ready to be used.

One-part thermally curable compositions according to the present disclosure are useful, for example, as adhesives, sealants, and potting compounds.

As used herein:

The term organic solvent refers to an intentionally added volatile organic fluid that dissolves or disperses one or more components of a mixture and does not serve any other chemically significant purpose.

The term “solvent-free” means containing less than 0.1 percent of free water and organic solvent combined.

The term “sulfhydryl group” refers to the —SH group.

The term “uretdione ring” refers to a divalent C₂N₂O₂ 4-membered ring having the structure:

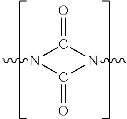

Features and advantages of the present disclosure will be further understood upon consideration of the detailed description as well as the appended claims.

### BRIEF DESCRIPTION OF THE DRAWINGS

FIG. 1 is a schematic side view of an exemplary article 100 according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The FIGURES may not be drawn to scale.

### DETAILED DESCRIPTION

The present disclosure provides one-part thermally curable compositions, cured compositions, and assemblies including them that may be useful for instance in coatings, sealants, and/or adhesives that may have good flowability and reactivity (e.g., without added solvent), acceptable cure and/or adhesion in a short amount of time, as compared to similar compositions containing isocyanates. Further, coatings, sealants, and adhesives according to at least certain embodiments of the present disclosure may be essentially free of isocyanates. This can be advantageous because isocyanates can be sensitizers upon first contact (e.g., to skin) such that subsequent contact causes inflammation. Further, coatings, sealants, and adhesives containing isocyanates exhibit more sensitivity to water than other compounds, as noted above, so minimizing an isocyanate content in a coating, sealant, or adhesive may improve reliability during curing.

Uretdiones can be formed by the 2+2 cycloaddition reaction of two isocyanate groups and has the following general formula:

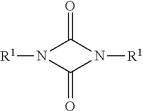

wherein each R¹ is independently an organic residue. If one or both R groups contain an isocyanato group, then further reaction to prepare a uretdione-containing compound is possible; for example, as shown below:

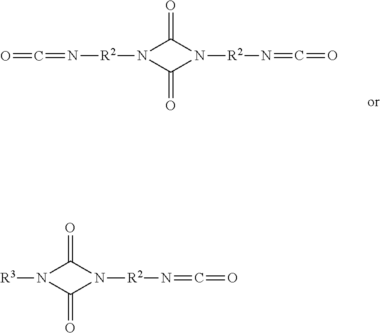

wherein R² represents a divalent organic residue (preferably alkylene, arylene, or alkarylene) having from 1 to 18 carbon atoms, preferably having from 4 to 14 carbon atoms, and more preferably 4 to 8 carbon atoms, and R³ represents an organic residue free of isocyanato groups (preferably alkyl, aryl, aralkyl, or alkaryl) having from 1 to 18 carbon atoms, preferably having from 4 to 14 carbon atoms, and more preferably 4 to 8 carbon atoms. Reaction of residual isocyanate groups with mono-ols (monohydroxy alcohols) or polyols (polyhydroxy alcohols) can be used to convert the residual isocyanate groups to carbamate esters and, in the case of polyols, to uretdione-containing compounds having a uretdione functionality of 2 or more.

Isocyanate dimerization to form a uretdione is typically done using a catalyst. Examples of dimerization catalysts are: trialkylphosphines, aminophosphines and aminopyridines such as dimethylaminopyridines, and tris(dimethylamino)phosphine, as well as any other dimerization catalyst known to those skilled in the art. The result of the dimerization reaction depends, in a manner known to the skilled person, on the catalyst used, on the process conditions and on the polyisocyanates employed. In particular, it is possible for products to be formed which contain on average more than one uretdione group per molecule, the number of uretdione groups being subject to a distribution.

Polyisocyanates containing uretdione groups are well known and their preparation is described in, for example, U.S. Pat. No. 4,476,054 (Disteldorf et al.); U.S. Pat. No. 4,912,210 (Disteldorf et al.); and U.S. Pat. No. 4,929,724 (Engbert et al.), and in European Pat No. EP 0 417 603 (Bruchmann). The reaction, conducted optionally in solvent, but preferably without solvent, is terminated by addition of catalyst poisons when a desired conversion has been reached. Excess monomeric isocyanate is separated off afterward by short-path evaporation. If the catalyst is sufficiently volatile, the reaction mixture can be freed from the catalyst at the same time as monomer is separated off. In that case, there is no need to add catalyst poisons.

By including polyisocyanate compounds, uretdione-containing compounds having an average uretdione ring functionality greater than 1 can be prepared. As used herein, the term “polyisocyanate” means any organic compound that has two or more reactive isocyanate (—NCO) groups in a single molecule such as, for example, diisocyanates, triisocyanates, tetraisocyanates, and mixtures thereof. Exemplary polyisocyanates that can be used to prepare uretdione-containing compounds include: 1) aliphatic diisocyanates such as 1,2-ethylene diisocyanate; 1,4-tetramethylene diisocyanate; 1,6-hexamethylene diisocyanate; 2,2,4-trimethyl-1,6-hexamethylene diisocyanate; 2,4,4-trimethyl-1,6-hexamethylene diisocyanate; 1,9-diisocyanato-5-methylnonane; 1,8-diisocyanato-2,4-dimethyloctane; 1,12-dodecane diisocyanate; ω,ω-diisocyanatodipropyl ether; cyclobutene 1,3-diisocyanate; cyclohexane 1,3-diisocyanate; cyclohexane 1,4-diisocyanate; 3-isocyanatomethyl-3,5,5-trimethylcyclohexyl isocyanate, 1,4-diisocyanatomethyl-2,3,5,6-tetramethylcyclohexane; decahydro-8-methyl-(1,4-methanol-naphthalen)-2,5-ylenedimethylene diisocyanate; decahydro-8-methyl-(1,4-methanol-naphthalen)-3,5-ylenedimethylene diisocyanate; hexahydro-4,7-methanoindan-1,5-ylenedimethylene diisocyanate; hexahydro-4,7-methanoindan-2,5-ylenedimethylene diisocyanate; hexahydro-4,7-methanoindan-1,6-ylenedimethylene diisocyanate; hexahydro-4,7-methanoindan-2,5-ylenedimethylene diisocyanate, hexahydro-4,7-methanoindan-1,5-ylene diisocyanate; hexahydro-4,7-methanoindan-2,5-ylene diisocyanate; hexahydro-4,7-methanoindan-1,6-ylene diisocyanate; hexahydro-4,7-methanoindan-2,6-ylene diisocyanate; 2,4-hexahydrotolylene diisocyanate; 2,6-hexahydrotolylene diisocyanate; 4,4′-methylenedicyclohexyl diisocyanate; 2,2′-methylenedicyclohexyl diisocyanate; 2,4′-methylene-dicyclohexyl diisocyanate; 4,4′-diisocyanato-3,3′,5,5′-tetramethyldicyclohexylmethane; 4,4′-diisocyanato-2,2′,3,3,5,5′,6,6′-octamethyldicyclohexylmethane; ω,ω-diisocyanato-1,4-diethylbenzene; 1,4-diisocyanatomethyl-2,3,5,6-tetramethylbenzene; 2-methyl-1,5-diisocyanatopentane; 2-ethyl-1,4-diisocyanatobutane; 1,10-diisocyanatodecane; 1,5-diisocyanatohexane; 1,3-diisocyanato-methylcyclohexane; 1,4-diisocyanatomethylcyclohexane; 2) aromatic diisocyanates such as 2,4′-diphenylmethane diisocyanate; 4,4′-biphenylene diisocyanate; 3,3′-dimethoxy-4,4′-biphenyl diisocyanate; 3,3′-dimethyl-4,4′-biphenyl diisocyanate; 3,3′-dimethyl-4,4′-diphenylmethane diisocyanate; xylene diisocyanate; toluenediisocyanate; 3-methyldiphenylmethane-4,4′-diisocyanate; 1,1-bis(4-isocyanatophenyl)cyclohexane; m- or p-phenylene diisocyanates; chlorophenylene-2,4-diisocyanate; 1,5-diisocyanatonaphthalene; 3,5′-dimethyldiphenyl-4,4′-diisocyanate; diphenyl ether-4,4′-diisocyanate; and 3) combinations thereof. Triisocyanates which may be used include, for example, trimerized isocyanurate versions of the diisocyanates listed above (e.g., the isocyanurate trimer of 1,6-hexamethylene diisocyanate and related compounds such as DESMODUR N 3300 from Covestro LLC, Pittsburgh, Pa.).

Mono-functional isocyanates may also be used (e.g., to vary the uretdione-containing compound average uretdione ring functionality. Examples include vinyl isocyanate; methyl isocyanatoformate; ethyl isocyanate; isocyanato(methoxy)methane; allyl isocyanate; ethyl isocyanatoformate; isopropyl isocyanate; propyl isocyanate; trimethylsilyl isocyanate; ethyl isocyanatoacetate; butyl isocyanate; cyclopentyl isocyanate; 2-isocyanato-2-methyl-propionic acid methyl ester; ethyl 3-isocyanatopropionate; 1-isocyanato-2,2-dimethylpropane; 1-isocyanato-3-methylbutane; 3-isocyanatopentane; pentyl isocyanate; 1-ethoxy-3-isocyanatopropane; phenyl isocyanate; hexyl isocyanate; 1-adamantyl isocyanate; ethyl 4-(isocyanatomethyl)cyclohexanecarboxylate; decyl isocyanate; 2-ethyl-6-isopropylphenyl isocyanate; 4-butyl-2-methylphenyl isocyanate; 4-pentylpheny] isocyanate; undecyl isocyanate; 4-biphenylyl isocyanate; 4-phenoxyphenyl isocyanate; 2-benzylphenyl isocyanate; 4-benzylphenyl isocyanate; diphenylmethyl isocyanate; 4-(benzyloxy)phenyl isocyanate; hexadecyl isocyanate; octadecyl isocyanate; and combinations thereof. Preferred compounds include, for example, uretdione-containing compounds derived from hexamethylene diisocyanate.

The conversion of uretdione-containing compounds having a single uretdione ring to a uretdione-containing compound having at least 2 uretdione rings (i.e., a polyuretdione) may be accomplished by reaction of the free NCO groups with hydroxyl-containing compounds, which include monomers, polymers, or mixtures thereof. Examples of such compounds include, but are not limited to, polyesters, polythioethers, polyethers, polycaprolactams, polyepoxides, polyesteramides, polyurethanes or low molecular mass di-, tri- and/or tetraols as chain extenders, and if desired, mono-ols as chain terminators, for example, as described in EP 0 669 353, EP 0 669 354, DE 30 30 572, EP 0 639 598, EP 0 803 524, and U.S. Pat. No. 7,709,589. Useful uretdione-containing compounds may optionally contain isocyanurate, biuret, and/or iminooxadiazinedione groups in addition to the uretdione groups.

Uretdione-containing compounds having at least 2 uretdione groups, such as from 2 to 10 uretdione groups, and typically containing from 5 to 45% uretdione, 10 to 55% urethane, and less than 2% isocyanate groups are disclosed in U.S. Pat. No. 9,080,074 (Schaffer et al.).

One preferred uretdione-containing compound is a hexamethylene diisocyanate-based blend of materials comprising uretdione functional groups, commercially available as DESMODUR N3400 from Covestro, Pittsburgh, Pa. Additional uretdione-containing compounds are commercially available from Covestro as CRELAN EF 403, CRELAN LAS LP 6645, CRELAN VP LS 2386, and METALINK U/ISOQURE TT from Isochem Incorporated, New Albany, Ohio.

The uretdione-containing compound has an average uretdione ring functionality of at least 1.2. Accordingly, at least some components of the uretdione-containing compound contain more than one uretdione functional group. In some embodiments, the uretdione-containing compound has an average uretdione ring functionality of at least 1.2, at least 1.3, at least 1.4, at least 1.5, at least 1.6, or even at least 1.7, up to and including 1.8, 1.9, 2.0, 2.1, 2.2, 2.3, 2.4, 2.5, 2.6, 2.7, 2.8, 2.9, 3, or more, in any combination. For example, the average uretdione ring functionality of the uretdione-containing compound may be, for example, >1.2, 1.2 to 3, inclusive, or 1.3 to 2.6, inclusive, of a uretdione functional group in a backbone of the polymeric material.

As mentioned hereinabove, polyols can be used to create uretdione-containing compounds having an average uretdione ring functionality of greater than 1 (e.g., at least 2 or at least 3).

One exemplary simplified general reaction scheme of a uretdione-containing compound with a polyol and a mono-ol is provided in exemplary Scheme 1 (below), wherein Z and L represent divalent organic linking groups, and R represents a monovalent organic group:

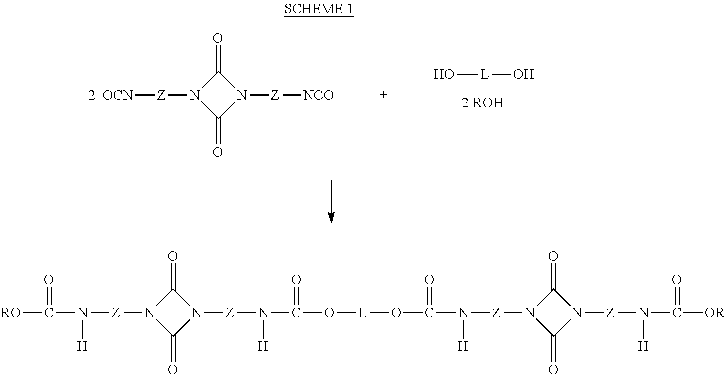

The at least one uretdione-containing compound also typically comprises one or more carbamylene (—O—C(═O)NH—) groups per molecule. The carbamylene groups may be formed by the reaction of polyol(s) with isocyanate groups present on uretdione-containing compounds. For example, the at least one uretdione-containing compound may have an average of at least 2, at least 2.5, at least 3, at least 4, at least 5, or even at least 6 carbamylene groups up to 6, 7, 8, 9, 10, 11, 12, 13, 14, or even 15 carbamylene groups, or more, in any combination. For example, the at least one uretdione-containing compound may have an average of 2 to 15, inclusive, or 2 to 10, inclusive, of carbamylene groups.

In some preferred embodiments, the at least one polyuretdione has an average isocyanate content of less than 2 weight percent, less than 1 weight percent, less than 0.5 weight percent, 0.1 weight percent, or even less than 0.01 weight percent.

Useful mono-ols may be primary, secondary, linear, cyclic, and/or branched, for example. They may include, for example, C₁-C₆ alkanols (e.g., methanol, ethanol, propanol, hexanol, cyclohexanol), C₃-C₈ alkoxyalkanols (e.g., methoxyethanol, ethoxyethanol, propoxy propanol, or ethoxydodecanol), and polyalkyleneoxide mono-ols (e.g., mono methyl-terminated polyethylene oxide or mono ethyl-terminated polypropylene oxide). Other mono-ols can also be used, as will be understood by those of ordinary skill in the art. Some preferred mono-ols include 2-butanol, isobutanol, methanol, ethanol, propanol, pentanol, hexanol, and 2-ethylbutanol. Preferred mono-ols may have branched structures or secondary hydroxyl groups that help maintain flowability of the uretdione-containing oligomers with high solids content including, for example, 2-butanol, isobutanol, 2-ethylhexanol, and more preferably 2-butanol.

Suitable polyols may be primary, secondary, linear, cyclic, and/or branched, for example. They may be, for example, an alkylene polyol, a polyester polyol, or a polyether polyol. Often the polyol is a diol, such as a branched diol. Exemplary suitable polyols include branched alcohols, secondary alcohols, and polyether glycols. Examples include straight or branched chain alkane polyols, such as 1,2-ethanediol, 1,3-propanediol, 1,2-propanediol, 1,4-butanediol, 1,3-butanediol, 2-methyl-1,3-propanediol, glycerol, neopentyl glycol, trimethylolethane, trimethylolpropane, di-trimethylolpropane, erythritol, pentaerythritol and di-pentaerythritol, 2-ethylhexane-1,3-diol; polyalkylene glycols, such as di-, tri- and tetraethylene glycol, and di-, tri- and tetrapropylene glycol; cyclic alkane polyols, such as cyclopentanediol, cyclohexanediol, cyclohexanetriol, cyclohexanedimethanol, hydroxypropyl-cyclohexanol and cyclohexanediethanol; aromatic polyols, such as dihydroxybenzene, benzenetriol, hydroxybenzyl alcohol and dihydroxytoluene; bisphenols, such as 4,4′-isopropylidenediphenol (bisphenol A); 4,4′-oxybisphenol, 4,4′-dihydroxybenzophenone, 4,4′-thiobisphenol, phenolphthalein, bis(4-hydroxyphenyl)methane (bisphenol F), 4,4′-(1,2-ethenediyl)bisphenol and 4,4′-sulfonylbisphenol; halogenated bisphenols, such as 4,4′-isopropylidenebis(2,6-dibromophenol), 4,4′-isopropylidenebis(2,6-dichlorophenol) and 4,4′-isopropylidenebis(2,3,5,6-tetrachlorophenol); alkoxylated bisphenols, such as alkoxylated 4,4′-isopropylidenediphenol having one or more alkoxy groups, such as ethoxy, propoxy, alpha-butoxy and beta-butoxy groups; and biscyclohexanols, which can be prepared by hydrogenating the corresponding bisphenols, such as 4,4′-isopropylidene-biscyclohexanol, 4,4′-oxybiscyclohexanol, 4,4′-thiobiscyclohexanol and bis(4-hydroxycyclohexanol)methane; higher polyalkylene glycols such as, e.g., polytetramethylene ether glycols having a number average molecular weight (Mₙ) of from 200 to 2900 grams per mole; hydroxyl-bearing acrylics, such as those formed from the copolymerization of (meth)acrylates and hydroxy functional (meth)acrylates, such as methyl methacrylate and hydroxyethyl methacrylate copolymers; and hydroxy functional polyesters, such as those formed from the reaction of diols, such as butanediol, and diacids or diesters, such as adipic acid or diethyl adipate; and combinations thereof. Preferred diols may have branching or secondary hydroxyl groups that help maintain flowability of the uretdione-containing oligomers with high solids content including, for example, 1,3-butanediol and neopentyl glycol.

In some preferred embodiments, the polyol has from 2 to 50 carbon atoms, preferably from 2 to 18 carbon atoms, and more preferably 2 to 8 carbon atoms. In some preferred embodiments, the polyol is polymeric and has from 10 to 200 carbon atoms. Examples include hydroxyl-terminated polyether diols and hydroxyl-terminated polyester diols.

Useful commercially available polyols include, for example, those from Covestro LLC, Pittsburgh, Pa., as DESMOPHEN 1652, DESMOPHEN 800, DESMOPHEN 850, DESMOPHEN C 1100, DESMOPHEN C 1200, DESMOPHEN C 2100, DESMOPHEN C 2200, and DESMOPHEN C XP 2716.

In some preferred embodiments, the at least one polyuretdione comprises a reaction product of a diisocyanate reacted with itself, a first hydroxyl-containing compound having a single OH group, wherein the first hydroxyl-containing compound is a primary alcohol or a secondary alcohol, and a second hydroxyl-containing compound having more than one OH group, wherein the second hydroxyl-containing compound is a diol and the reaction product comprises 0.2 to 0.5, inclusive, of diol equivalents relative to isocyanate equivalents.

In some embodiments, the uretdione-containing material comprises:
a uretdione-containing compound represented by the formula

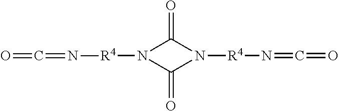

wherein R⁴ is independently selected from a C₄ to C₁₄ alkylene, arylene, and alkarylene; a first hydroxyl-containing compound represented by the formula represented by:

R⁵OH
wherein:
R⁵ is selected from R⁶, R⁷, and a C₁ to C₅₀ alkyl;
R⁶ is represented by the formula:

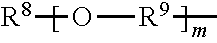

wherein m=1 to 20, R⁸ is alkyl, and R⁹ is alkylene; and
R⁷ is represented by the formula:

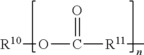

wherein n=1 to 20, R¹⁰ is alkyl, and R¹¹ is alkylene; and

wherein the second hydroxyl-containing compound is represented by the formula:

HO—R¹²—OH
wherein R¹² is selected from R¹³, alkylene, and alkylene substituted with an —OH group,
wherein R¹³ is represented by formula:

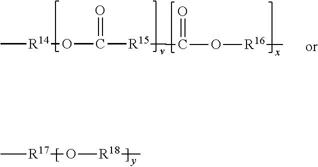

wherein each of R¹⁴, R¹⁵, R¹⁶, R¹⁷, and R¹⁸ is independently selected from an alkylene, wherein each of v and y is independently selected from 1 to 40, and wherein x is selected from 0 to 40.

The uretdione-containing material may be added in any amount, preferably in an amount of 5 to 99 percent by weight, more preferably 10 to 98 percent by weight, based on the total weight of the one-part thermally curable composition.

Exemplary thermally activatable amine curatives should be substantially inactive at room temperature but be capable of activation at elevated temperature, preferably above about 50° C. to 120° C. or higher, depending on the system and application, to effect curing of the one-part thermally curable composition. Suitable thermally activatable amine curatives are described in British Patent 1, 121, 196 (Ciba Geigy AG), European Patent Application 138465A (Ajinomoto Co.) and European Patent Application 193068A (Asahi Chemical). Other suitable thermally activatable amine curatives include a reaction product of (i) a polyfunctional epoxy compound, (ii) an imidazole compound such as 2-ethyl-4-methylimidazole and (iii) phthalic anhydride. The polyfunctional epoxy compound may be any compound having two or more epoxy groups in the molecule as described in U.S. Pat. No. 4,546,155 (Hirose et al.). Other suitable thermally activatable amine curatives are those given in U.S. Pat. No. 5,077,376 (Dooley). Additional thermally activatable amine curatives include 2-heptadeoylimidazole, 2-phenyl-4, 5-dihydroxymethylimidazole, 2-phenyl-4-methyl-5-hydroxymethylimidazole, 2-phenyl-4-benzyl-5-hydroxymethylimidazole, 2, 4-diamino-8-2-methylimidazolyl-(1)-ethyl-5-triazine, and addition products of triazine with isocyanuric acid, succinohydrazide, adipohydrazide, isophthalohydrazide, o-oxybenzohydrazide, and salicylohydrazide.

Commercially available thermally activatable amine curatives (also sometimes termed latent hardeners) include, for example, those having the trade designations: AMICURE MY-24, AMICURE GG-216, and AMICURE ATU CARBAMATE from Ajinomoto Fine-Techno Co., Inc., Kanagawa, Japan; NOVACURE HX-372 (commercially available from Asahi Kasei Kogyo K. K., Osaka, Japan); AJICURE such as, for example, grades PN-23 (100-105° C.), PN-H (120-125° C.), PN-31 (115-120° C.), PN-40 (105-110° C.), and MY-H (125-130° C.) from Ajinomoto Fine-Techno Co., Inc.; encapsulated modified imidazoles such as those available as TECHNICURE LC-100 encapsulated modified imidazole (m.p.=90-100° C.) and Technicure LC-80 encapsulated modified imidazole (m.p.=90-100° C.) from ACCI Specialty Materials, Linden, N.J.; and latent amine curing agents available as FUJICURE FXR-1020 (m.p.=115-130° C.), FUJICURE FXR-1030 (m.p.=135-145° C.), FUJICURE FXR-1081 (m.p.=115-125° C.), FUJICURE FXR-1090FA (m.p.=110-120° C.), FUJICURE FXR-1121 (128-138° C.), SANCURE LC-125 (110-125° C.) from Sanho Chemical Co., Ltd., Kaohsiung City, Taiwan.

The thermally activatable amine curative is typically included in an amount sufficient to effect curing of the one-part thermally curable composition when heated sufficiently. For example, thermally activatable amine curative may suitably be present in amounts of from about 5 to about 45 parts, desirably from about 1 to about 30 parts, more desirably from about 10 to about 20 parts by weight per 100 parts of the epoxy resin and uretdione, combined. Preferably, thermally activatable amine curative is present in an amount of 0.5 to 30 percent by weight, more preferably 1 to 15 percent by weight, based on the total weight of the one-part thermally curable composition.

One-part thermally curable compositions according to the present disclosure may optionally further comprise an epoxy resin comprising one or more epoxy compounds that can be monomeric or polymeric, and aliphatic, cycloaliphatic, heterocyclic, aromatic, hydrogenated, and/or a mixture thereof. Preferred epoxy compounds contain an average of more than 1.5 epoxy groups per molecule and more preferably at least 2 epoxide groups per molecule.

The epoxy resin can include linear polymeric epoxides having terminal epoxy groups (e.g., a diglycidyl ether of a polyoxyalkylene glycol), polymeric epoxides having skeletal epoxy groups (e.g., polybutadiene poly epoxy), polymeric epoxides having pendant epoxy groups (e.g., a glycidyl methacrylate polymer or copolymer), or a mixture thereof.

Exemplary epoxy compounds include, for example, aliphatic (including cycloaliphatic) and aromatic epoxy compounds. The epoxy compound(s) may be monomeric, oligomeric, or polymeric epoxides, or a combination thereof. The epoxy resin may be a pure compound or a mixture comprising at least two epoxy compounds. The epoxy resin typically has, on average, at least 1 epoxy (i.e., oxiranyl) group per molecule, preferably at least about 1.5 and more preferably at least about 2 epoxy groups per molecule. In some cases, 3, 4, 5, or even 6 epoxy groups may be present, on average. Polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). Other useful epoxy resins are polyhydric phenolic formaldehyde condensation products as well as polyglycidyl ethers that contain as reactive groups only epoxy groups or hydroxy groups. The “average” number of epoxy groups per molecule can be determined by dividing the total number of epoxy groups in the epoxy-containing material by the total number of epoxy-containing molecules present.

The choice of epoxy resin may depend upon the intended end use. For example, epoxides with flexible backbones may be desired where a greater amount of ductility is needed in the bond line. Materials such as diglycidyl ethers of bisphenol A and diglycidyl ethers of bisphenol F can help impart desirable structural adhesive properties upon curing, while hydrogenated versions of these epoxies may be useful for compatibility with substrates having oily surfaces.

Commercially available epoxy compounds include octadecylene oxide, epichlorohydrin, styrene oxide, vinylcyclohexene oxide, glycidol, glycidyl methacrylate, vinylcyclohexene dioxide, 3,4-epoxycyclohexylmethyl-3,4-epoxycyclohexenecarboxylate, 3,4-epoxy-6-methylcyclohexylmethyl-3,4-epoxy-6-methylcyclohexene carboxylate, bis(3,4-epoxy-6-methylcyclohexylmethyl) adipate, bis(2,3-epoxycyclopentyl) ether, dipentene dioxide, silicone resin containing epoxy functionality, flame retardant epoxy resins (e.g., DER-580, a brominated bisphenol type epoxy resin available from Dow Chemical Co.), 1,4-butanediol diglycidyl ether of phenol-formaldehyde novolac (e.g., DEN-431 and DEN-438 from Dow Chemical Co.), and resorcinol diglycidyl ether (e.g., Kopoxite from Koppers Company, Inc.), bis(3,4-epoxycyclohexyl)adipate, 2-(3,4-epoxycyclohexyl-5,5-spiro-3,4-epoxy) cyclohexene metadioxane, vinylcyclohexene monoxide 1,2-epoxyhexadecane, alkyl glycidyl ethers such as (e.g., HELOXY Modifier 7 from Momentive Specialty Chemicals, Inc., Waterford, N.Y.), alkyl C12-C14 glycidyl ether (e.g., HELOXY Modifier 8 from Momentive Specialty Chemicals, Inc.), butyl glycidyl ether (e.g., HELOXY Modifier 61 from Momentive Specialty Chemicals, Inc.), cresyl glycidyl ether (e.g., HELOXY Modifier 62 from Momentive Specialty Chemicals, Inc.), p-tert-butylphenyl glycidyl ether (e.g., HELOXY Modifier 65 from Momentive Specialty Chemicals, Inc.), polyfunctional glycidyl ethers such as diglycidyl ether of 1,4-butanediol (e.g., HELOXY Modifier 67 from Momentive Specialty Chemicals, Inc.), diglycidyl ether of neopentyl glycol (e.g., HELOXY Modifier 68 from Momentive Specialty Chemicals, Inc.), diglycidyl ether of cyclohexanedimethanol (e.g., HELOXY Modifier 107 from Shell Chemical Co.), trimethylolethane triglycidyl ether (e.g., HELOXY Modifier 44 from Momentive Specialty Chemicals, Inc.), trimethylolpropane triglycidyl ether (e.g., HELOXY Modifier 48 from Momentive Specialty Chemicals, Inc.), polyglycidyl ether of an aliphatic polyol (e.g., HELOXY Modifier 84 from Momentive Specialty Chemicals, Inc.), polyglycol diepoxide (e.g., HELOXY Modifier 32 from Momentive Specialty Chemicals, Inc.), bisphenol F epoxides, 9,9-bis[4-(2, 3-epoxypropoxy)-phenyl]fluorenone (e.g., Epon 1079 from Momentive Specialty Chemicals, Inc.).

In some embodiments, the epoxy resin contains one or more epoxy compounds having an epoxy equivalent weight of from 100 g/mole to 1500 g/mol. More preferably, the epoxy resin contains one or more epoxy compounds having an epoxy equivalent weight of from 300 g/mole to 1200 g/mole. Even more preferably, the curable composition contains two or more epoxy compounds, wherein at least one epoxy resin has an epoxy equivalent weight of from 300 g/mole to 500 g/mole, and at least one epoxy resin has an epoxy equivalent weight of from 1000 g/mole to 1200 g/mole.

Useful epoxy compounds also include aromatic glycidyl ethers, e.g., such as those prepared by reacting a polyhydric phenol with an excess of epichlorohydrin, cycloaliphatic glycidyl ethers, hydrogenated glycidyl ethers, and mixtures thereof. Such polyhydric phenols may include resorcinol, catechol, hydroquinone, and the polynuclear phenols such as p,p′-dihydroxydibenzyl, p,p′-dihydroxydiphenyl, p,p′-dihydroxyphenyl sulfone, p,p′-dihydroxybenzophenone, 2,2′-dihydroxy-1,1-dinaphthylmethane, and the 2,2′-, 2,3′-, 2,4′-, 3,3′-, 3,4′-, and 4,4′-isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyl-dicyclohexylmethane, and dihydroxydiphenylcyclohexane.

Exemplary epoxy compounds also include glycidyl ethers of bisphenol A, bisphenol F, and novolac resins as well as glycidyl ethers of aliphatic or cycloaliphatic diols. Examples of commercially available glycidyl ethers include diglycidyl ethers of bisphenol A such as those available as EPON 828, EPON 1001, EPON 1310, and EPON 1510 from Hexion Specialty Chemicals GmbH, Rosbach, Germany; those available under the trade name D.E.R. (e.g., D.E.R. 331, 332, and 334) from Dow Chemical Co., Midland, Mich.; those available under the trade name EPICLON from Dainippon Ink and Chemicals, Inc. (e.g., EPICLON 840 and 850) and those available under the trade name YL-980 from Japan Epoxy Resins Co., Ltd.); diglycidyl ethers of bisphenol F (e.g., those available under the trade name EPICLON from Dainippon Ink and Chemicals, Inc. (e.g., EPICLON 830)); glycidyl ethers of novolac resins (e.g., novolac epoxy resins, such as those available under the trade name D.E.N. from Dow Chemical Co. (e.g., D.E.N. 425, 431, and 438)); and flame retardant epoxy resins (e.g., D.E.R. 580, a brominated bisphenol type epoxy resin available from Dow Chemical Co.). In some embodiments, aromatic glycidyl ethers, such as those prepared by reacting a dihydric phenol with an excess of epichlorohydrin, may be preferred. In some embodiments, nitrile rubber modified epoxies may be used (e.g., KELPOXY 1341 available from CVC Chemical).

Low viscosity epoxy compound(s) may be included in the epoxy resin, for example, to reduce viscosity. Examples of low viscosity epoxy compounds include: cyclohexanedimethanol diglycidyl ether, resorcinol diglycidyl ether, p-tert-butylphenyl glycidyl ether, cresyl glycidyl ether, diglycidyl ether of neopentyl glycol, triglycidyl ether of trimethylolethane, triglycidyl ether of trimethylolpropane, triglycidyl p-aminophenol, N,N′-diglycidylaniline, N,N,N′,N′-tetraglycidyl m-xylylenediamine, and vegetable oil polyglycidyl ether.

The optional epoxy resin may be added in any amount, preferably in an amount of 1 to 95 percent by weight, more preferably 5 to 75 percent by weight, based on the total weight of the one-part thermally curable composition.

One-part thermally curable compositions according to the present disclosure may optionally further comprise one or more polythiols. Useful polythiols are organic compounds having an average —SH group functionality of at least 1, at least 2, at least 3, at least 4, or even at least 6 thiol groups. Combinations of polythiols may be used. The average thiol functionality of the at least one thiol-containing compound is at least 2 (which may include some monofunctional thiol). Preferably, the average thiol functionality of the at least one thiol-containing compound is from 2 to 7, more preferably 2 to 5, more preferably 2.0 to 4.5, and more preferably 2.5 to 4.3. Preferred combinations include miscible mixtures, although this is not a requirement. In some embodiments, the polythiol has an average sulfhydryl group functionality of at least 1.8 and/or less than or equal to 5.

Many thiols having one thiol group, when combined with sufficient polythiol, are useful in practice of the method according to the present disclosure. Polythiols having at least two thiol groups (i.e., polythiols) are useful in practice of the method according to the present disclosure. In some embodiments, the polythiol may be an alkylene, arylene, alkylarylene, arylalkylene, or alkylenearylalkylene having at least two mercaptan groups, wherein any of the alkylene, alkylarylene, arylalkylene, or alkylenearylalkylene are optionally interrupted by one or more oxa (i.e., —O—), thia (i.e., —S—), or imino groups (i.e., —NR¹⁹— wherein R¹⁹ is a hydrocarbyl group or H), and optionally substituted by alkoxy or hydroxyl.

Examples of useful dithiols include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethyl sulfide, methyl-substituted dimercaptodiethyl sulfide, dimethyl-substituted dimercaptodiethyl sulfide, dimercaptodioxaoctane, 1,5-dimercapto-3-oxapentane,benzene-1,2-dithiol, benzene-1,3-dithiol, benzene-1,4-dithiol, and tolylene-2,4-dithiol. Examples of polythiols having more than two mercaptan groups include propane-1,2,3-trithiol; 1,2-bis[(2-mercaptoethyl)thio]-3-mercaptopropane; tetrakis(7-mercapto-2,5-dithiaheptyl)methane; and trithiocyanuric acid.

Also useful are polythiols formed from the esterification of polyols with thiol-containing carboxylic acids or their derivatives. Examples of polythiols formed from the esterification of polyols with thiol-containing carboxylic acids or their derivatives include those made from the esterification reaction between thioglycolic acid or 3-mercaptopropionic acid and several polyols to form the mercaptoacetates or mercaptopropionates, respectively.

Examples of polythiol compounds preferred because of relatively low odor level include, but are not limited to, esters of thioglycolic acid, α-mercaptopropionic acid, and β-mercaptopropionic acid with polyhydroxy compounds (polyols) such as diols (e.g., glycols), triols, tetraols, pentaols, and hexaols. Specific examples of such polythiols include, but are not limited to, ethylene glycol bis(thioglycolate), ethylene glycol bis(β-mercaptopropionate), trimethylolpropane tris(thioglycolate), trimethylolpropane tris(β-mercaptopropionate) and ethoxylated versions, pentaerythritol tetrakis(thioglycolate), pentaerythritol tetrakis(β-mercaptopropionate), and tris(hydroxyethyl)isocyanurate tris(p-mercaptopropionate). However, in those applications where concerns about possible hydrolysis of the ester exists, these polyols are typically less desirable.

Suitable polythiols also include those commercially available as THIOCURE PETMP (pentaerythritol tetra(3-mercaptopropionate)), TMPMP (trimethylolpropane tri(3-mercaptopropionate)), ETTMP (ethoxylated trimethylolpropane tri(3-mercaptopropionate) such as ETTMP 1300 and ETTMP 700), GDMP glycol di(3-mercaptopropionate), TMPMA (trimethylolpropane tri(mercaptoacetate)), TEMPIC (tris[2-(3-mercaptopropionyloxy)ethyl] isocyanurate), and PPGMP (propylene glycol 3-mercaptopropionate) from Bruno Bock Chemische Fabrik GmbH & Co. KG. A specific example of a polymeric polythiol is polypropylene-ether glycol bis(β-mercaptopropionate), which is prepared from polypropylene-ether glycol (e.g., PLURACOL P201, Wyandotte Chemical Corp.) and β-mercaptopropionic acid by esterification.

Suitable polythiols also include those prepared from esterification of polyols with thiol-containing carboxylic acids or their derivatives, those prepared from a ring-opening reaction of epoxides with H₂S (or its equivalent) across carbon-carbon double bonds, polysulfides, polythioethers, and polydiorganosiloxanes. Specifically, these include the 3-mercaptopropionates (also referred to as β-mercaptopropionates) of ethylene glycol and trimethylolpropane (the former from Chemische Fabrik GmbH & Co. KG, the latter from Sigma-Aldrich); POLYMERCAPTAN 805C (mercaptanized castor oil); POLYMERCAPTAN 407 (mercaptohydroxy soybean oil) from Chevron Phillips Chemical Co. LLP, and CAPCURE, specifically CAPCURE 3-800 (a polyoxyalkylenetriol with mercapto end groups of the structure R³[O(C₃H₆O)ₙCH₂CH(OH)CH₂SH]₃ wherein R³ represents an aliphatic hydrocarbon group having 1-12 carbon atoms and n is an integer from 1 to 25), from Gabriel Performance Products, Ashtabula, Ohio, and GPM-800, which is equivalent to CAPCURE 3-800, also from Gabriel Performance Products.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.).

In some embodiments, the polythiol in the method according to the present disclosure is oligomeric or polymeric. Examples of useful oligomeric or polymeric polythiols include polythioethers and polysulfides. Polythioethers include thioether linkages (i.e., —S—) in their backbone structures. Polysulfides include disulfide linkages (i.e., —S—S—) in their backbone structures.

Polythioethers can be prepared, for example, by reacting dithiols with dienes, diynes, divinyl ethers, diallyl ethers, ene-ynes, alkynes, or combinations of these under free-radical conditions. Useful dithiols include any of the dithiols listed above. Examples of suitable divinyl ethers include divinyl ether, ethylene glycol divinyl ether, butanediol divinyl ether, hexanediol divinyl ether, diethylene glycol divinyl ether, triethylene glycol divinyl ether, tetraethylene glycol divinyl ether, cyclohexanedimethanol divinyl ether, polytetrahydrofuryl divinyl ether, and combinations of any of these. Useful divinyl ethers of formula CH₂═CHO(R²⁰O)ₘCH═CH₂, in which m is a number from 0 to 10, R²⁰ is C₂ to C₆ branched alkylene. Such compounds can be prepared by reacting a polyhydroxy compound with acetylene.

Examples of compounds of this type include compounds in which R²⁰ is an alkyl-substituted methylene group such as —CH(CH₃)— (e.g., those obtained from BASF, Florham Park, N.J., as “PLURIOL”, for which R²⁰ is ethylene and m is 3.8) or an alkyl-substituted ethylene (e.g., —CH₂CH(CH₃)— such as those obtained from International Specialty Products of Wayne, N.J., as “DPE” (e.g., DPE-2 and DPE-3). Examples of other suitable dienes, diynes, and diallyl ethers include 4-vinyl-1-cyclohexene, 1,5-cyclooctadiene, 1,6-heptadiyne, 1,7-octadiyne, and diallyl phthalate. Small amounts of trifunctional compounds (e.g., triallyl-1,3,5-triazine-2,4,6-trione, 2,4,6-triallyloxy-1,3,5-triazine) may also be useful in the preparation of oligomers.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.). In some embodiments, the polythioether is represented by formula HSR²¹[S(CH₂)₂O[R²²O]ₘ(CH₂)₂SR²¹]ₙSH, wherein each R²¹ and R²² is independently a C2-6 alkylene, wherein alkylene may be straight-chain or branched, C₆₋₈ cycloalkylene, C₆₋₁₀ alkylcycloalkylene, —[(CH₂)ₚX]_{q}(CH₂)ᵣ in which at least one —CH₂— is optionally substituted with a methyl group, X is one selected from the group consisting of 0, S and —NR²³—, where R²³ denotes hydrogen or methyl, m is a number from 0 to 10, n is a number from 1 to 60, p is an integer from 2 to 6, q is an integer from 1 to 5, and r is an integer from 2 to 10. Polythioethers with more than two mercaptan groups may also be useful.

Polythioethers can also be prepared, for example, by reacting dithiols with diepoxides, which may be carried out by stirring at room temperature, optionally in the presence of a tertiary amine catalyst (e.g., 1,4-diazabicyclo[2.2.2]octane (DABCO)). Useful dithiols include any of those described above. Useful epoxides can be any of those having two epoxide groups. In some embodiments, the diepoxide is a bisphenol diglycidyl ether, wherein the bisphenol (i.e., —OC₆H₅CH₂C₆H₅O—) may be unsubstituted (e.g., bisphenol F), or either of the phenyl rings or the methylene group may be substituted by halogen (e.g., F, Cl, Br, I), methyl, trifluoromethyl, or hydroxymethyl. Polythioethers prepared from dithiols and diepoxides have pendent hydroxyl groups and can have structural repeating units represented by formula —SR²⁴SCH₂CH(OH)CH₂OC₆H₅CH₂C₆H₅OCH₂CH(OH)CH₂SR²⁴S—, wherein R²⁴ is as defined above, and the bisphenol (i.e., —OC₆H₅CH₂C6H₅O—) may be unsubstituted (e.g., bisphenol F), or either of the phenyl rings or the methylene group may be substituted by halogen (e.g., F, Cl, Br, I), methyl, trifluoromethyl, or hydroxymethyl. Mercaptan terminated polythioethers of this type can also be reacted with any of the dienes, diynes, divinyl ethers, and diallyl ethers.

Other useful polythiols can be formed from the addition of hydrogen sulfide (H₂S) (or its equivalent) across carbon-carbon double bonds. For example, dipentene and triglycerides which have been reacted with H₂S (or its equivalent). Specific examples include dipentene dimercaptan and those polythiols available as POLYMERCAPTAN 358 (mercaptanized soybean oil) and POLYMERCAPTAN 805C (mercaptanized castor oil) from Chevron Phillips Chemical Co. LLP. At least for some applications, the preferred polythiols are POLYMERCAPTAN 358 and 805C since they are produced from largely renewable materials, i.e., the triglycerides, soybean oil and castor oil, and have relatively low odor in comparison to many thiols. Useful triglycerides have at least 2 sites of unsaturation, i.e., carbon-carbon double bonds, per molecule on average, and sufficient sites are converted to result in at least 2 thiols per molecule on average. In the case of soybean oil, this requires a conversion of approximately 42 percent or greater of the carbon-carbon double bonds, and in the case of castor oil this requires a conversion of approximately 66 percent or greater of the carbon-carbon double bonds. Typically, higher conversion is preferred, and POLYMERCAPTAN 358 and 805C can be obtained with conversions greater than approximately 60 percent and 95 percent, respectively. Useful polythiols of this type also include those derived from the reaction of H₂S (or its equivalent) with the glycidyl ethers of bisphenol A epoxy resins, bisphenol F epoxy resins, and novolak epoxy resins. A preferred polythiol of this type is QX11, derived from bisphenol A epoxy resin, from Japan Epoxy Resins (JER) as EPOMATE. Other polythiols suitable include those available as EPOMATE QX10 and EPOMATE QX20 from JER.

Still other useful polythiols are polysulfides that contain thiol groups such as those available as THIOKOL LP-2, LP-3, LP-12, LP-31, LP-32, LP-33, LP-977, and LP-980 from Toray Fine Chemicals Co., Ltd., and polythioether oligomers and polymers such as those described in PCT Publ. No. WO 2016130673 A1 (DeMoss et al.).

The optional polythiol may be added in any amount, preferably in an amount of 0 to 50 percent by weight, more preferably 0 to 37 percent by weight, based on the total weight of the one-part thermally curable composition.

An optional acidic stabilizer may be added to the one-part thermally curable composition to inhibit the amine curative by an acid-base interaction, thereby prolonging the working time and/or storage stability of the one-part thermally curable composition. Exemplary acidic stabilizers include carboxylic acids (including fluorinated carboxylic acids), phosphonic acids (including fluorinated carboxylic acids), sulfonic acids (including fluorinated carboxylic acids), perfluorosulfonimides, and Lewis acids (e.g., BF₃). In some embodiments, the optional acidic stabilizer is selected from the group consisting of BF₃, C₁-C₁₆ monocarboxylic acids, C₁-C₁₆ dicarboxylic acids, C₆-C₁₄ arylcarboxylic acids, C₁-C₁₆ monosulfonic acids, C₁-C₁₆ disulfonic acids, C₆-C₁₄ arylsulfonic acids, C₁-C₁₆ monophosphonic acids, C₁-C₁₆ diphosphonic acids, C₆-C₁₄ arylphosphonic acids, and combination thereof.

The optional acidic stabilizer may be added in any amount, preferably in an amount of 0.005 to 5.0 percent by weight, more preferably 0.01 to 1 percent by weight, based on the total weight of the one-part thermally curable composition.

In preferred embodiments, the one-part thermally curable composition contains less than 10 weight percent of total solvent content, preferably less than 5 weight percent of total solvent content, more preferably less than 1 weight percent of total solvent content. In some embodiments, the one-part thermally curable composition is solvent-free.

In preferred embodiments, one-part thermally curable compositions according to the present disclosure are flowable at 20° C.

One-part curable and cured compositions according to the present disclosure may further comprise one or more additives such as, for example, plasticizers, non-reactive diluents, fillers, flame retardants, and colorants.

A plasticizer is often added to the curable composition to make the polymeric material more flexible, softer, and more workable (e.g., easier to process). More specifically, the mixture resulting from the addition of the plasticizer to the polymeric material typically has a lower glass transition temperature compared to the polymeric material alone. The glass transition temperature of the curable composition can be lowered, for example, by at least 30° C., at least 40° C., at least 50° C., at least 60° C., or even at least 70° C. by the addition of one or more plasticizers. The temperature change (i.e., decrease) tends to correlate with the amount of plasticizer added to the polymeric material. It is the lowering of the glass transition temperature that usually leads to the increased flexibility, increased elongation, and increased workability. Some example plasticizers include various phthalate esters such as diethyl phthalate, diisobutyl phthalate, dibutyl phthalate, diisoheptyl phthalate, dioctyl phthalate, diisooctyl phthalate, dinonyl phthalate, diisononyl phthalate, diisodecyl phthalate, and benzylbutyl phthalate; various adipate esters such as di-2-ethylhexyl adipate, dioctyl adipate, diisononyl adipate, and diisodecyl adipate; various phosphate esters such as tri-2-ethylhexyl phosphate, 2-ethylhexyl diphenyl phosphate, trioctyl phosphate, and tricresyl phosphate; various trimellitate esters such as tris-2-ethylhexyl trimellitate and trioctyl trimellitate; various sebacate and azelate esters; and various sulfonate esters. Other example plasticizers include polyester plasticizers that can be formed by a condensation reaction of propanediols or butanediols with adipic acid.

In certain embodiments, the one-part thermally curable composition is used in an application where it is disposed between two substrates, wherein solvent removal (e.g., evaporation) is restricted, especially when one or more of the substrates comprises a moisture impermeable material (e.g., steel or glass). In such cases, the polymeric material has a solids content of 90% or greater, 92% or greater, 94% or greater, 95% or greater, 96% or greater, 98% or greater, or 99% or greater. Likewise, in such embodiments where solvent removal is restricted, the first part (Part A), the second part (Part B), or both parts of a two-part curable composition according to the present disclosure preferably comprises a solids content of at least 90%, at least 92%, at least 94%, at least 95%, at least 96%, at least 98%, or even at least 99%. Components that are considered “solids” include, for instance and without limitation, polymers, oligomers, monomers, hydroxyl-containing compounds, and additives such as plasticizers, catalysts, non-reactive diluents, and fillers. Typically, only solvents (e.g., water, organic solvent(s), and combinations thereof) do not fall within the definition of solids.

For convenient handleability, the curable composition typically comprises a dynamic viscosity of 10 Poise (P) or greater as determined using a Brookfield viscometer, 50 P or greater, 100 P or greater, 150 P or greater, 250 P or greater, 500 P or greater, 1,000 P or greater, 1,500 P or greater, 2,000 P or greater, 2,500 P or greater, or even 3,000 P or greater; and 10,000 P or less, 9,000 P or less, 8,000 P or less, 7,000 P or less, 6,000 P or less, 5,000 P or less, or even 4,000 P or less, as determined using a Brookfield viscometer. Stated another way, the polymeric material may exhibit a dynamic viscosity of 10 Poise (P) to 10,000 P, inclusive, or 10 P to 4,000 P, inclusive, as determined using a Brookfield viscometer. Conditions for the dynamic viscosity test include use of a LV4 spindle at a speed of 0.3 or 0.6 revolutions per minute (RPM) at 24° C.

The one-part thermally curable composition may be disposed on a substrate (e.g., as a potting compound or sealant) or disposed (e.g., sandwiched) between first and second substrates, for example when used as an adhesive, gap filler, or sealant. If used as an adhesive, the one-part thermally curable composition is applied to one or both substrates, and pressed together to form an adhesive bond after curing. If used as a sealant pressing may not be performed. After curing a bonded assembly results. Exemplary substrates include metals, ceramics, glass, plastic, wood, and circuit boards.

The one-part thermally curable composition is typically applied to (e.g., disposed on) the surface of one or both substrate using conventional techniques such as, for example, dispensing, bar coating, roll coating, curtain coating, rotogravure coating, knife coating, spray coating, spin coating, or dip coating techniques. Coating techniques such as bar coating, roll coating, and knife coating are often used to control the thickness of a layer of the one-part thermally curable composition. In certain embodiments, the disposing comprises spreading the one-part thermally curable composition on the first major surface of the first substrate, for instance when the one-part thermally curable composition is dispensed (e.g., with a nozzle) on the surface of the substrate such that the mixture does not cover the entirety of a desired area.

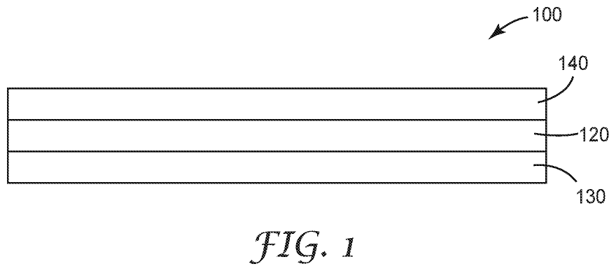

Referring to FIG. 1, assembly 100 comprises at least partially cured composition 120 (e.g., an adhesive) disposed on a first substrate 130. Optional second substrate 140 contacts at least partially cured composition 120, sandwiching it between first and second substrates 130, 140.

### SELECT EMBODIMENTS OF THE PRESENT DISCLOSURE

In a first embodiment, the present disclosure provides a one-part thermally curable composition comprising:
at least one polyuretdione, the at least one polyuretdione having an average uretdione ring functionality of at least 1.2, wherein the at least one polyuretdione is a reaction product of components comprising:
   a) a uretdione-containing material comprising a reaction product of a diisocyanate reacted with itself,
   b) a first hydroxyl-containing compound having a single OH group, wherein the first hydroxyl-containing compound is a primary alcohol or a secondary alcohol; and
   c) a second hydroxyl-containing compound having more than one OH group, wherein the second hydroxyl-containing compound is a polyol and the reaction product comprises 0.2 to 0.5, inclusive, of hydroxyl equivalents relative to isocyanate equivalents;
thermally activatable amine curative;
optional epoxy resin;
optional polythiol having an average sulfhydryl group functionality of at least 2; and optional acid stabilizer.

In a second embodiment, the present disclosure provides a one-part thermally curable composition according to the first embodiment, wherein the at least one polyuretdione has an average isocyanate content of less than 0.1 weight percent.

In a third embodiment, the present disclosure provides a one-part thermally curable composition according to the first or second embodiment, wherein:

the uretdione-containing material comprises a compound represented by the formula:

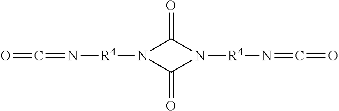

wherein R⁴ is independently selected from a C₄ to C₁₄ alkylene, arylene, and alkarylene; a first hydroxyl-containing compound represented by the formula represented by:

R⁵OH
wherein:
R⁵ is selected from R⁶, R⁷, and a C₁ to C₅₀ alkyl;
R⁶ is represented by the formula:

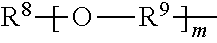

wherein m=1 to 20, R⁸ is alkyl, and R⁹ is alkylene; and
R⁷ is represented by the formula:

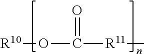

wherein n=1 to 20, R¹⁰ is alkyl, and R¹¹ is alkylene; and

wherein the second hydroxyl-containing compound is represented by the formula:

HO—R¹²—OH
wherein R¹² is selected from R¹³, alkylene, and alkylene substituted with an —OH group,
wherein R¹³ is represented by formula:

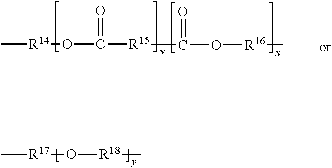

wherein each of R¹⁴, R¹⁵, R¹⁶, R¹⁷, and R¹⁸ is independently selected from an alkylene, wherein each of v and y is independently selected from 1 to 40, and wherein x is selected from 0 to 40.

In a fourth embodiment, the present disclosure provides a one-part thermally curable composition according to any one of the first to third embodiments, wherein the one-part thermally curable composition is solvent-free.

In a fifth embodiment, the present disclosure provides a one-part thermally curable composition according to any one of the first to fourth embodiments, wherein the one-part thermally curable composition is flowable at 20° C.

In a sixth embodiment, the present disclosure provides a one-part thermally curable composition according to any one of the first to fifth embodiments, wherein said epoxy resin is present.

In a seventh embodiment, the present disclosure provides a one-part thermally curable composition according to any one of the first to sixth embodiments, wherein said acid stabilizer is present. In an eighth embodiment, the present disclosure provides a one-part thermally curable composition according to any one of the first to seventh embodiments, wherein said polythiol is present.

In a ninth embodiment, the present disclosure provides a one-part thermally curable composition according to the eighth embodiment, wherein said polythiol has an average sulfhydryl group functionality of at least 1.8.

In a tenth embodiment, the present disclosure provides a one-part thermally curable composition according to the eighth embodiment, wherein said polythiol has an average sulfhydryl group functionality of less than or equal to 5.

In an eleventh embodiment, the present disclosure provides a one-part thermally curable composition according to any one of the eighth to tenth embodiments, wherein the at least one polyuretdione has an average isocyanate content of less than 0.1 weight percent.

In a twelfth embodiment, the present disclosure provides a one-part thermally curable composition according to any one of the eighth to eleventh embodiments, wherein the one-part thermally curable composition is flowable at 20° C.

In a thirteenth embodiment, the present disclosure provides a one-part thermally curable composition according to any one of the eighth to twelfth embodiments, wherein said epoxy resin is present.

In a fourteenth embodiment, the present disclosure provides a one-part thermally curable composition according to any one of the eighth to thirteenth embodiments, wherein said acid stabilizer is present.

In a fifteenth embodiment, the present disclosure provides an adhesive composition comprising a cured reaction product of a one-part thermally curable composition according to any preceding embodiment.

In a sixteenth embodiment, the present disclosure provides an adhesive composition according to the fourteenth embodiment disposed on a substrate.

In a seventeenth embodiment, the present disclosure provides an adhesive composition according to the fourteenth embodiment disposed (e.g., sandwiched) between a first substrate and a second substrate.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Table 1, below, lists various materials used in the Examples.

TABLE 1

| DESIGNATION | DESCRIPTION | SOURCE |
|---|---|---|
| | benzoic acid | Alfa Aesar, |
| | | Haverhill, |
| | | Massachusetts |
| | citric acid | Alfa Aesar |
| | oxalic acid | Alfa Aesar |
| | isopropylidene malonate | Alfa Aesar |
| 1,3-BD | 1,3-butanediol | Alfa Aesar |
| 2-BuOH | 2-butanol | Alfa Aesar |
| 2-EtHexOH | 2-ethylhexanol | Alfa Aesar |
| APN-23-J | thermally activatable amine | Ajinomoto Co., |
| | curative obtained as | Inc., Kanagawa, |
| | AJICURE PN-23-J | Japan |
| APN-40-J | thermally activatable | Ajinomoto Co., |
| | amine curative obtained as | Inc. |
| | AJICURE PN-40-J | |
| BARM | 1-benzyl-5-phenylbarbituric | Chemische Fabrik |
| | acid | Berg GmbH, |
| | | Bitterfeld-Wolfen, |
| | | Germany |
| BiND | bismuth neodecanoate | Gelest, Morrisville, |
| | | Pennsylvania |
| DICY | thermally activatable amine | Evonik Industries |
| | curative obtained as | AG, Essen, |
| | Amicure CG-1200G | Germany |
| DMDO | 3,6-dioxa-1,8-octane-dithiol, | TCI America, |
| | difunctional thiol curative | Portland, Oregon |
| DN3400 | HDI-based oligomer with | Covestro, |
| | uretdione functional groups | Leverkusen, |
| | obtained under the trade | Germany |
| | designation DESMODUR | |
| | N3400 | |
| E828 | bisphenol A epoxy solution | Hexion Inc. |
| | obtained under the trade | |
| | designation EPON 828 | |
| EGE21 | 1,4-butanediol diglycidyl | Emerald |
| | ether obtained | Performance |
| | as ERISYS GE-21 | Materials |
| EGE31 | triglycidyl ether of | Emerald |
| | trimethylolethane | Performance |
| | obtained as ERISYS GE-31 | Materials |
| EGE6 | 2-ethylhexyl glycidyl | Emerald |
| | ether obtained as | Performance |
| | ERISYS GE-6 | Materials |
| EGS 110 | glycidyl ester of neodecanoic | Emerald |
| | acid obtained as | Performance |
| | ERISYS GS-110 | Materials |
| EP-101 | latent hardener obtained | Hexion Inc., |
| | as EPIKURE P-101 | Columbus, Ohio |
| Epoxy-Mix | epoxy mixture of 86.5% | |
| | weight percent | |
| | of EPON 828, and 2.7% | |
| | weight percent | |
| | of each of EGE31, | |
| | EGE6, EGE21, | |
| | EGS110, and H505 | |
| Et3B | triethylborane | Alfa Aesar |
| FXR 1081 | thermally activatable amine | Sanho Chemical |
| | curative, obtained as | Co., Ltd. |
| | FUJICURE FXR-1081 | |
| H505 | castor oil polyglycidyl ether | Hexion Inc. |
| | obtained as HELOXY 505 | |
| KARENZ | multifunctional thiol obtained | Showa Denko |
| | as KARENZ MT PE1 | America, Inc., |
| | | New York, |
| | | New York |
| NPG | 2,2-dimethyl-i,3-propanediol | Alfa Aesar |
| PETMP | pentaerythritol | TCI America |
| | tetrakis(3-mercaptopropionate), | |
| | tetrafunctional thiol curative | |
| TsOH | p-toluenesulfonic acid | Alfa Aesar |
| T1000 | poly(tetramethylene ether) | Invista, Wichita, |
| | glycol with a molecular | Kansas |
| | weight of 1000 g/mol obtained | |
| | as TERATHANE 1000 | |
| T650 | poly(tetramethylene ether) | Invista |
| | glycol with a molecular | |
| | weight of 650 g/mol obtained | |
| | as TERATHANE 650 | |
| TLC-100 | thermally activatable amine | ACCI Specialty |
| | curative obtained as | Materials, |
| | TECHNICURE LC-100 | Kansas City, |
| | | Missouri |
| TLC-80 | thermally activatable amine | ACCI Specialty |
| | curative obtained as | Materials |
| | TECHNICURE LC-80 | |
| TMPTMP | trimethylolpropane | TCI America |
| | tri(3-mercaptopropionate), | |
| | trifunctional thiol curative | |

### Test Methods

### General Oligomer Preparation

Bismuth neodecanoate, Desmodur N3400, the chain extender, and the capping group were added to a glass jar as reported in Tables 2-4. The amounts of alcohol that were added corresponded to the equivalent values reported in Table 2-4 (relative to the equivalents of isocyanate). The mixture was stirred magnetically at 700 revolutions per minute (RPM). Initially the mixture was hazy, and after about one minute, the mixture became clear and slightly warm. The mixture then continued to exotherm noticeably. Stirring was continued for a total of 5 minutes, and the resultant oligomer was then allowed to cool to room temperature.

### FTIR Characterization of Oligomers

The infrared (IR) spectra of the oligomer samples and the cured adhesives were obtained using an infrared Fourier Transform spectrometer (Nicolet 6700 FT-IR Spectrometer, Thermo Scientific, Madison, Wis.) equipped with a Smart iTR Diamond Attenuated Total Reflectance (ATR) accessory. For all the oligomers the isocyanate peak at 2260 cm⁻¹ was not present in the infrared spectrum, indicating that the isocyanate had reacted completely with the alcohols during the preparation of the oligomers. For all the oligomers, a strong uretdione signal at 1760 cm⁻¹ was observed. For all the cured adhesives, the uretdione signal at 1760 cm⁻¹ had nearly disappeared, indicating reaction of the uretdione group during the cure of the adhesives.

### General Uncured Resin Preparation

Uretdione-containing polymeric resin compositions are described in Tables 5 and 6. The polymeric material (containing uretdione functional groups) and the optional components (acid, thiol, and/or epoxy) as reported in Tables 5-6, were each added to a plastic cup and mixed for 45 seconds to 90 seconds using a speed mixer (DAC 150 FV from Flack-tek, Landrum, S.C.). Thermally-activatable amine curative/catalyst was then added to the plastic cup, and the mixture was mixed for 15 to 30 seconds using a combination of hand mixing with a wood applicator stick and the speed mixer. The gel time of uretdione oligomers was determined by monitoring the time required to reach a gel. The mixture was hand-mixed periodically until the material could not be drawn without breaking, which was determined to be the gel point. Time was calculated from the addition of amine curative until the moment gelation occurred.

### Thermal Property Measurement for Uncure and Cured Resin Compositions

Differential Scanning Calorimetry (DSC) was performed using a Model Q2000 DSC (available from TA Instruments, New Castle, Del.) and evaluated using the TA Universal Analysis software package. A sample of uncured resin weighing between 4 and 20 milligrams was placed in an aluminum pan, weighed, and sealed. The sample was then heated at a rate of 5° C./minute from 30° C. to 150° C. (unless designated otherwise in the table). In cases where a glass transition temperature (T_{g}) was also determined, this heating ramp was followed by cooling at 20° C./minute down to −50° C., then reheating at a rate of 5° C./minute back up to 150° C. (unless designated otherwise in the table). In this manner the cure onset temperature, cure peak temperature, and heat of cure energy of the uncured resins were determined during the first heat cycle; and the glass transition temperature (T_{g}) of the cured resins was determined during the second cycle and reported in Table 7. The T_{g} was taken as the inflection point of the thermal transition.

Cure times of uncured resin compositions were evaluated by rapidly heating a sample to a specific temperature and holding it at that temperature for 1 to 3 hours using the same DSC equipment, software, and sample size, as described for the measurement of thermal properties above. The cure time was reported as the time it took for the heat flow due to exotherm to return to <0.05 Watt/gram and is reported in Table 8.

### Viscosity of Uncured Compositions

The flowability of uncured compositions was determined by means of viscosity measurements. The viscosity of the curable uretdione compositions was measured by a shear rate sweep using an Ares G2 Rheometer (commercially available from TA Instruments) in the cone and plate mode of operation. The measurements were taken at 25° C. (77° F.) using a 25 millimeters (mm) diameter stainless steel cone with a cone angle of 0.099 radians and a 50 mm plate. Two to three grams of curable resin composition were placed between the cone and plate. The cone and plate were then closed to provide a 0.465 mm gap (at the tip) filled with resin. Excess resin was scraped off the edges with a spatula. Viscosity was measured using a shear rate sweep from 20 to 0.1 Hertz and the viscosity at 4.1 Hertz and is reported in Table 9.

### Overlap Shear Adhesion Test Method

The performance of adhesives derived from uretdione-containing polymeric materials was determined using overlap shear tests. Aluminum coupons (25 mm×102 mm×1.6 mm) were sanded with 220 grit sandpaper, wiped with isopropanol, and dried. The uncured resin was then applied to a 25 mm×13 mm area on one end of the aluminum coupon, and two pieces of stainless steel wire (0.25 mm diameter) were placed in the resin to act as bondline spacers. One end of a second aluminum coupon was then pressed into to the mixture to produce an overlap of approximately 13 mm. A binder clip was placed on the sample, and it was allowed to cure according to the time and temperature in Table 9. The samples were tested to failure in shear mode at a rate of 2.54 mm/minute using a tensile load frame with self-tightening grips (from MTS Systems, Eden Prairie, Minn., or from Instron Corporation, Norwood, Mass.). After failure, the length of the overlap area was measured. The overlap shear value was then calculated by dividing the peak load by the overlap area. Overlap shear test results are summarized in Table 9 for the various formulations tested.

TABLE 2

| | | | | | | | | | CALCULATED |
|---|---|---|---|---|---|---|---|---|---|
| | CAPPING GROUP | | | CHAIN EXTENDER | | | | | URETDIONE |
| | | | Relative | | | Relative | DN3400, | BiND, | FUNCTIONALITY, |
| EXAMPLE | Type | g | equiv. | Type | g | equiv. | g | g | fUD |
| 1A | 2-BuOH | 0.90 | 0.63 | NPG | 0.37 | 0.37 | 3.72 | 0.01 | 1.74 |
| 1B | 2-BuOH | 4.52 | 0.39 | NPG | 5.02 | 0.61 | 30.38 | 0.08 | 4.00 |
| 1C | 2-BuOH | 22.35 | 0.64 | T1000 | 85.97 | 0.36 | 91.39 | 1.00 | 1.74 |

TABLE 3

| | CAPPING GROUP | | | CHAIN EXTENDER 1 | | | CHAIN EXTENDER 2 | | | | | |
|---|---|---|---|---|---|---|---|---|---|---|---|---|
| | | | Relative | | | Relative | | | Relative | DN3400, | BiND, | |
| EXAMPLE | Type | g | equiv. | Type | g | equiv. | Type | g | equiv. | g | g | fUD |
| 2A | 2-BuOH | 0.64 | 0.74 | NPG | 0.075 | 0.14 | 1,3-BD | 0.07 | 0.12 | 2.22 | 0.006 | 1.37 |
| 2B | 2-BuOH | 0.64 | 0.73 | NPG | 0.11 | 0.21 | 1,3-BD | 0.03 | 0.06 | 2.21 | 0.006 | 1.37 |
| 2C | 2-BuOH | 12.3 | 0.58 | NPG | 5.01 | 0.34 | T650 | 8.00 | 0.09 | 55.4 | 0.15 | 1.99 |

TABLE 4

| | CAPPING GROUP | | | CHAIN EXTENDER 1 | | | CHAIN EXTENDER 2 | | | | | |
|---|---|---|---|---|---|---|---|---|---|---|---|---|
| | | | Relative | | | Relative | | | Relative | DN3400, | BiND, | |
| EXAMPLE | Type | g | equiv. | Type | g | equiv. | Type | g | equiv. | g | g | fUD |
| 3A | 2-BuOH | 5.32 | 0.19 | 2-EtHexOH | 28.03 | 0.56 | NPG | 4.98 | 0.25 | 73.9 | 0.2 | 1.37 |
| 3B | 2-BuOH | 15.96 | 0.56 | 2-EtHexOH | 9.34 | 0.19 | NPG | 4.98 | 0.25 | 73.9 | 0.2 | 1.37 |

TABLE 5

| | | | AMINE | | | | | |
|---|---|---|---|---|---|---|---|---|
| | OLIGOMER | | CATALYST/CURATIVE | | ACID | | THIOL | |
| EXAMPLE | Type | g | Type | g | Type | g | Type | g |
| 4 | EXAMPLE 1A | 8.37 | FX 1081 | 0.5 | BARM | 0.03 | PETMP | 1.63 |
| 5 | EXAMPLE 1A | 8.27 | TLC-80 | 0.5 | BARM | 0.03 | TMPMP | 1.73 |
| 6 | EXAMPLE 1A | 8.85 | TLC-100 | 0.5 | BARM | 0.03 | DMDO | 1.15 |
| 7 | EXAMPLE 1A | 8.37 | APN-23-J | 0.5 | BARM | 0.03 | PETMP | 1.63 |
| 8 | EXAMPLE 1A | 8.27 | APN-40-J | 0.50 | BARM | 0.03 | TMPMP | 1.73 |
| 9 | EXAMPLE 1A | 8.85 | EP-101 | 0.50 | BARM | 0.03 | DMDO | 1.15 |
| 10 | EXAMPLE 1A | 1.66 | APN-23-J | 0.10 | BARM | 0.006 | Karenz | 0.34 |
| 11 | EXAMPLE 2C | 2.58 | APN-23-J | 0.03 | BARM | 0.009 | PETMP | 0.42 |
| 12 | EXAMPLE 2C | 2.58 | APN-23-J | 0.09 | BARM | 0.009 | PETMP | 0.42 |
| 13 | EXAMPLE 2C | 2.58 | APN-23-J | 0.15 | BARM | 0.009 | PETMP | 0.42 |
| 14 | EXAMPLE 2C | 2.58 | APN-23-J | 0.27 | BARM | 0.011 | PETMP | 0.42 |
| 15 | EXAMPLE 2C | 2.58 | APN-23-J | 0.15 | BARM | 0.003 | PETMP | 0.42 |
| 16 | EXAMPLE 2C | 2.58 | APN-23-J | 0.15 | BARM | 0.03 | PETMP | 0.42 |
| 17 | EXAMPLE 2C | 2.58 | APN-23-J | 0.15 | BARM | 0.06 | PETMP | 0.42 |
| 18 | EXAMPLE 2C | 7.19 | FX1081 | 0.40 | TsOH | 0.024 | PETMP | 0.81 |
| 19 | EXAMPLE 2C | 7.19 | FX1081 | 0.40 | oxalic acid | 0.024 | PETMP | 0.81 |
| 20 | EXAMPLE 1A | 1.68 | APN-23-J | 0.10 | Et3B | 0.006 | PETMP | 0.16 |
| 21 | EXAMPLE 1A | 1.66 | APN-23-J | 0.10 | | | Karenz | 0.34 |
| 22 | EXAMPLE 1A | 0.84 | TLC-80 | 0.05 | | | PETMP | 0.16 |
| 23 | EXAMPLE 1A | 0.83 | TLC-100 | 0.05 | | | TMPMP | 0.17 |
| 24 | EXAMPLE 1A | 0.89 | APN-23-J | 0.05 | | | DMDO | 0.12 |
| 25 | EXAMPLE 2C | 1.00 | APN-23-J | 0.06 | | | | |
| 26 | EXAMPLE 2C | 1.00 | APN-23-J | 0.12 | | | | |
| 27 | EXAMPLE 2C | 1.00 | APN-40-J | 0.12 | | | | |
| 28 | EXAMPLE 2C | 1.00 | APN-23-J | 0.12 | BARM | 0.003 | | |
| 29 | EXAMPLE 2C | 1.00 | APN-23-J | 0.25 | | | | |
| 30 | EXAMPLE 2C | 1.00 | FX 1081 | 0.11 | BARM | 0.003 | | |
| 31 | EXAMPLE 2C | 1.00 | APN-23-J | 0.12 | BARM | 0.010 | | |
| 32 | EXAMPLE 2C | 1.00 | APN-40-J | 0.12 | BARM | 0.010 | | |
| 33 | EXAMPLE 2C | 1.00 | TLC-80 | 0.05 | | | | |
| 34 | EXAMPLE 2C | 1.00 | TLC-100 | 0.05 | BARM | 0.003 | | |
| 35 | EXAMPLE 2C | 1.00 | APN-23-J | 0.12 | BiND | 0.006 | | |
| 36 | EXAMPLE 2C | 1.00 | APN-23-J | 0.12 | TsOH | 0.006 | | |
| 37 | EXAMPLE 2C | 1.00 | APN-23-J | 0.12 | Citric Acid | 0.006 | | |
| 38 | EXAMPLE 2C | 1.00 | APN-23-J | 0.12 | Benzoic Acid | 0.006 | | |
| COMPARATIVE | EXAMPLE 2C | 1.00 | APN-23-J/DICY | 0.001/0.025 | BARM | 0.003 | | |
| EXAMPLE A | | | | | | | | |
| COMPARATIVE | EXAMPLE 2C | 1.00 | APN-40-J/DICY | 0.001/0.025 | BARM | 0.003 | | |
| EXAMPLE B | | | | | | | | |
| COMPARATIVE | EXAMPLE 2C | 1.00 | EP-101/DICY | 0.001/0.025 | BARM | 0.003 | | |
| EXAMPLE C | | | | | | | | |
| COMPARATIVE | EXAMPLE 2C | 1.00 | TLC-80/DICY | 0.001/0.025 | BARM | 0.003 | | |
| EXAMPLE D | | | | | | | | |
| COMPARATIVE | EXAMPLE 2C | 1.00 | TLC-100/DICY | 0.001/0.025 | BARM | 0.003 | | |
| EXAMPLE E | | | | | | | | |
| 39 | EXAMPLE 1C | 1.00 | APN-23-J | 0.16 | BARM | 0.003 | | |
| 40 | EXAMPLE 1C | 1.00 | APN-23-J | 0.11 | BARM | 0.003 | | |
| 41 | EXAMPLE 1C | 1.00 | APN-23-J | 0.08 | BARM | 0.003 | | |
| 42 | EXAMPLE 1C | 1.00 | APN-23-J | 0.05 | BARM | 0.003 | | |
| 43 | EXAMPLE 1C | 1.00 | APN-23-J | 0.03 | BARM | 0.003 | | |
| 44 | EXAMPLE 1C | 1.00 | TLC-80 | 0.26 | BARM | 0.003 | | |
| 45 | EXAMPLE 1C | 1.00 | TLC-80 | 0.16 | BARM | 0.003 | | |
| 46 | EXAMPLE 1C | 1.00 | TLC-80 | 0.11 | BARM | 0.003 | | |
| 47 | EXAMPLE 1C | 1.00 | TLC-80 | 0.08 | BARM | 0.003 | | |
| 48 | EXAMPLE 1C | 1.00 | TLC-80 | 0.05 | BARM | 0.003 | | |
| COMPARATIVE | EXAMPLE 2C | 1.00 | | | | | | |
| EXAMPLE F | | | | | | | | |
| COMPARATIVE | EXAMPLE 1C | 1.00 | | | BiND | 0.006 | | |
| EXAMPLE G | | | | | | | | |
| COMPARATIVE | EXAMPLE 1C | 1.00 | | | BiND | 0.003 | | |
| EXAMPLE H | | | | | | | | |
| COMPARATIVE | EXAMPLE 1A | 1.66 | | | BARM | 0.006 | KARENZ | 0.34 |
| EXAMPLE I | | | | | | | | |
| COMPARATIVE | EXAMPLE 1A | 8.37 | | | BARM | 0.03 | PETMP | 1.63 |
| EXAMPLE J | | | | | | | | |
| COMPARATIVE | EXAMPLE 1A | 8.27 | | | BARM | 0.03 | TMPMP | 1.73 |
| EXAMPLE K | | | | | | | | |
| COMPARATIVE | EXAMPLE 1A | 8.85 | | | BARM | 0.03 | DMDO | 1.15 |
| EXAMPLE L | | | | | | | | |
| COMPARATIVE | EXAMPLE 1A | 1.66 | | | | | KARENZ | 0.34 |
| EXAMPLE M | | | | | | | | |
| COMPARATIVE | EXAMPLE 1A | 8.37 | | | | | PETMP | 1.63 |
| EXAMPLE N | | | | | | | | |
| COMPARATIVE | EXAMPLE 2C | 1.00 | DICY | 0.025 | | | | |
| EXAMPLE O | | | | | | | | |
| COMPARATIVE | EXAMPLE 2C | 1.00 | DICY | 0.025 | BARM | 0.003 | | |
| EXAMPLE P | | | | | | | | |

TABLE 6

| | | | | | | | | | | AMINE | |
|---|---|---|---|---|---|---|---|---|---|---|---|
| | OLIGOMER | | EPOXY | | Wt % | THIOL | | ACID | | CATALYST/CURATIVE | |
| EXAMPLE | Type | g | Type | g | EPOXY* | Type | g | Type | g | Type | g |
| 49 | EXAMPLE | 1.00 | EGE31 | 0.05 | 5% | TMPMP | 0.22 | BARM | 0.004 | TLC-80 | 0.06 |
| | 2A | | | | | | | | | | |
| 50 | EXAMPLE | 1.00 | E828 | 1.00 | 50% | TMPMP | 0.89 | BARM | 0.009 | TLC-80 | 0.14 |
| | 2B | | | | | | | | | | |
| 51 | EXAMPLE | 1.00 | E828 | 3.00 | 75% | TMPMP | 2.27 | BARM | 0.020 | TLC-80 | 0.31 |
| | 3A | | | | | | | | | | |
| 52 | EXAMPLE | 1.00 | E828 | 0.11 | 10% | TMPMP | 0.26 | BARM | 0.004 | TLC-80 | 0.07 |
| | 3B | | | | | | | | | | |
| 53 | EXAMPLE | 1.04 | E828 | 1.04 | 50% | TMPMP | 0.93 | BARM | 0.012 | APN-23-J | 0.15 |
| | 1B | | | | | | | | | | |
| 54 | EXAMPLE | 0.93 | Epoxy- | 1.07 | 54% | PETMP | 0.80 | BARM | 0.008 | APN-23-J | 0.14 |
| | 2C | | Mix | | | | | | | | |

*Wt % Epoxy calculated relative to amount of uretdione oligomer.

TABLE 7

| | | | CURE | CURE | | |
|---|---|---|---|---|---|---|
| | | | ONSET | PEAK | | |
| | | | TEMPER- | TEMPER- | HEAT | |
| | GEL | | ATURE, | ATURE, | OF CURE, | T_{g}, |
| EXAMPLE | TIME | | ° C. | ° C. | J/g | ° C. |
| 4 | >33 | days | 75.4 | 98.1 | Did not | 13.5 |
| | | | | | complete | |
| | | | | | cure | |
| 5 | <18 | days | 73.3 | 90 | 115.6 | 12 |
| 6 | <4 | days | 59.6 | 93.9 | 96.55 | 7.4 |
| 7 | >= 33 | days | 74.6 | 89.9 | 115.3 | 12.8 |
| 8 | <= 18 | days | 61 | 71.4 | 108.4 | 7.6 |
| 9 | <4 | days | 78.6 | 111.9 | Did not | |
| | | | | | complete | |
| | | | | | cure | |
| 10 | >13 | days | 94.9 | 107.7 | 98.6 | 7.7 |
| 11 | >13 | days | 73 | Did not | Did not | |
| | | | | reach peak | complete | |
| | | | | | cure | |
| 12 | >13 | days | 79.4 | 96.2 | 107 | |
| 13 | >13 | days | 66.5 | 83.1 | 112 | |
| 14 | >13 | days | 70.9 | 87.7 | 89.2 | |
| 15 | <13 | days | 57.8 | 73.7 | 104.6 | |
| 16 | <14 | days | 94.3 | 113.3 | Did not | |
| | | | | | complete | |
| | | | | | cure | |
| 17 | >13 | days | | Did not | Did not | |
| | | | | reach peak | complete | |
| | | | | | cure | |
| 18 | >18 | days | 58.2 | Did not | Did not | |
| | | | | reach peak | complete | |
| | | | | | cure | |
| 19 | >18 | days | 87.8 | Did not | Did not | |
| | | | | reach peak | complete | |
| | | | | | cure | |
| 20 | <13 | days | 82.4 | 91.1 | 100.7 | −7.7 |
| 21 | <13 | days | 63 | 82.7 | 101 | 8.6 |
| 22 | <4 | h | 44.7 | 65.5 | 23.1 | 12.9 |
| 23 | <4 | h | 38.5 | 51.9 | 54.9 | −9.3 |
| 24 | <4 | h | 111.8 | 133.2 | 18.0 | |
| 25 | | | 71.8 | 105.8 | 83.1 | −1.8 |
| 26 | | | 67.9 | 101.8 | 103.3 | 4.91 |
| 27 | | | 66.5 | 191.1 | 107.7 | −2 |
| 28 | | | 79.2 | 89.6 | 93.3 | |
| 29 | | | 58 | 145.6 | 270.2 | |
| 30 | | | 91.2 | 125.3 | 64.3 | |
| 31 | | | 80.7 | 95.8 | 81.9 | |
| 32 | | | 81.9 | 101.2 | 61.8 | |
| 33 | | | 88.2 | 103.1 | 17.14 | |
| 34 | | | 76.3 | 66.5 | 172.8 | |
| 35 | | | 89 | Did not | Did not | |
| | | | | reach peak | complete | |
| | | | | | cure | |
| 36 | | | 68.2 | 58.5 | 68.5 | |
| 37 | | | 99.7 | 72.5 | 40.1 | |
| 38 | | | 78.9 | 100.1 | 65.5 | |
| COMPAR- | | | Did not | | | |
| ATIVE | | | show signs | | | |
| EXAM- | | | of curing | | | |
| PLE A | | | | | | |
| COMPAR- | | | 176 | Did not | Did not | |
| ATIVE | | | | treach peak | complete | |
| EXAM- | | | | | cure | |
| PLE B | | | | | | |
| COMPAR- | | | Did not | | | |
| ATIVE | | | show signs | | | |
| EXAM | | | of curing | | | |
| PLE C | | | | | | |
| COMPAR- | | | 151 | Did not | Did not | |
| ATIVE | | | | reach peak | complete | |
| EXAM- | | | | | cure | |
| PLE D | | | | | | |
| COMPAR- | | | Did not | | | |
| ATIVE | | | show signs | | | |
| EXAM- | | | of curing | | | |
| PLE E | | | | | | |
| 39 | | | 89 | 97.6 | 67.2 | |
| 40 | | | 86.7 | 94.8 | 62.1 | |
| 41 | | | 89.2 | 98.4 | 27.3 | |
| 42 | | | 97.6 | 106.5 | 15.9 | |
| 43 | | | 101 | 110 | 5.9 | |
| 44 | | | 78.9 | 89.4 | 75.8 | |
| 45 | | | 85.1 | 94.8 | 65.7 | |
| 46 | | | 91.2 | 99.6 | 49.3 | |
| 47 | | | 92.3 | 99.9 | 21.5 | |
| 48 | | | 97.4 | 106.4 | 14.4 | |
| COMPAR- | | | Did not | | | |
| ATIVE | | | show signs | | | |
| EXAM- | | | of curing | | | |
| PLE F | | | | | | |
| COMPAR- | | | 145 | Did not | Did not | |
| ATIVE | | | | reach peak | complete | |
| EXAM- | | | | | cure | |
| PLE G | | | | | | |
| COMPAR- | | | 136 | Did not | Did not | |
| ATIVE | | | | reach peak | complete | |
| EXAM- | | | | | cure | |
| PLE H | | | | | | |
| COMPAR- | >13 | days | Did not | | | |
| ATIVE | | | show signs | | | |
| EXAM- | | | of curing | | | |
| PLE I | | | | | | |
| COMPAR- | >33 | days | Did not | | | |
| ATIVE | | | show signs | | | |
| EXAM- | | | of curing | | | |
| PLE J | | | | | | |
| COMPAR- | <= 32 | days | Did not | | | |
| ATIVE | | | show signs | | | |
| EXAM- | | | of curing | | | |
| PLE K | | | | | | |
| COMPAR- | <7 | days | 105.5 | Did not | Did not | |
| ATIVE | | | | reach peak | complete | |
| EXAM- | | | | | cure | |
| PLE L | | | | | | |
| COMPAR- | >13 | days | >140 C. | Did not | Did not | |
| ATIVE | | | | reach peak | complete | |
| EXAM- | | | | | cure | |
| PLE M | | | | | | |
| COMPAR- | <7 | days | 66.5 | Did not | Did not | |
| ATIVE | | | | reach peak | complete | |
| EXAM- | | | | | cure | |
| PLE N | | | | | | |
| COMPAR- | | | 179 | Did not | Did not | |
| ATIVE | | | | reach peak | complete | |
| EXAM- | | | | | cure | |
| PLE O | | | | | | |
| COMPAR- | | | 190 | Did not | Did not | |
| ATIVE | | | | reach peak | complete | |
| EXAM- | | | | | cure | |
| PLE P | | | | | | |
| 49 | <18 | days | 61.6 | 84.4 | 149.7 | 4.1 |
| 50 | >22 | days | 82.7 | 92.9 | 296.8 | 21.34 |
| 51 | >22 | days | 79.3 | 87.5 | 319.7 | 29.5 |
| 52 | <= 6 | days | 67.8 C. | 86.7 | 161.6 | 5.45 |
| 53 | | | 66.9 | 83.2 | 295.7 | |
| 54 | >19 | days | 63.4 | 82.2 | 316.4 | |

TABLE 8

| | CURE TEMPERATURE, | CURE TIME, |
|---|---|---|
| EXAMPLE | ° C. | minutes |
| 4 | 75 | 26.28 |
| 8 | 60 | 28.92 |
| 39 | 80 | 50.03 |
| 45 | 80 | 33.50 |
| 49 | 75 | 41.82 |
| 50 | 75 | 19.33 |
| 51 | 75 | 8.71 |
| 52 | 75 | 39.86 |

TABLE 9

| | OVERLAP | | |
|---|---|---|---|
| | SHEAR | STANDARD | |
| | ADHESION, | DEVIATION, | VISCOSITY, |
| EXAMPLE | psi (MPa) | psi (MPa) | Pa · s |
| 21 | 544 (3.74) | 221 (1.52) | 495 |
| 39 | 114 (0.79) | 13 (0.09) | 457 |
| 50 | 1648 (11.4) | 190 (1.31) | 11.5 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1-16. (canceled)

17. A one-part thermally curable composition comprising:
at least one polyuretdione, the at least one polyuretdione having an average uretdione ring functionality of at least 1.2, wherein the at least one polyuretdione is a reaction product of components comprising:
a) a uretdione-containing material comprising a reaction product of a diisocyanate reacted with itself,
b) a first hydroxyl-containing compound having a single OH group, wherein the first hydroxyl-containing compound is a primary alcohol or a secondary alcohol; and
c) a second hydroxyl-containing compound having more than one OH group, wherein the second hydroxyl-containing compound is a polyol and the reaction product comprises 0.2 to 0.5, inclusive, of hydroxyl equivalents relative to isocyanate equivalents;
thermally activatable amine curative; and
polythiol having an average sulfhydryl group functionality of at least 2.

18. The one-part thermally curable composition of claim 17 wherein the at least one polyuretdione has an average isocyanate content of less than 0.1 weight percent.

19. The one-part thermally curable composition of claim 17, wherein:
the uretdione-containing material comprises a compound represented by the formula: 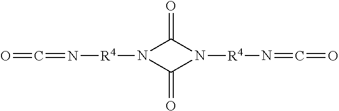
wherein R⁴ is independently selected from a C₄ to C₁₄ alkylene, arylene, and alkarylene;
a first hydroxyl-containing compound represented by the formula represented by:
R⁵OH
wherein:
R⁵ is selected from R⁶, R⁷, and a C₁ to C₅₀ alkyl;
R⁶ is represented by the formula: 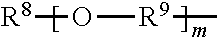
wherein m=1 to 20, R⁸ is alkyl, and R⁹ is alkylene; and
R⁷ is represented by the formula: 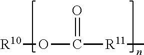
wherein n=1 to 20, R¹⁰ is alkyl, and R¹¹ is alkylene; and
wherein the second hydroxyl-containing compound is represented by the formula:
HO—R¹²—OH
wherein R¹² is selected from R¹³, alkylene, and alkylene substituted with an —OH group,
wherein R¹³ is represented by formula: 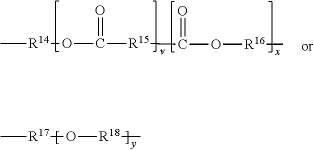
wherein each of R¹⁴, R¹⁵, R¹⁶, R¹⁷, and R¹⁸ is independently selected from an alkylene, wherein each of v and y is independently selected from 1 to 40, and wherein x is selected from 0 to 40.

20. The one-part thermally curable composition of claim 17, wherein the one-part thermally curable composition is solvent-free.

21. The one-part thermally curable composition of claim 17, wherein the one-part thermally curable composition is flowable at 20° C.

22. The one-part thermally curable composition of claim 17, further comprising epoxy resin.

23. The one-part thermally curable composition of claim 17, further comprising acid stabilizer.

24. The one-part thermally curable composition of claim 17, wherein said polythiol has an average sulfhydryl group functionality of at least 1.8.

25. The one-part thermally curable composition of claim 17, wherein said polythiol has an average sulfhydryl group functionality of less than or equal to 5.

26. The one-part thermally curable composition of claim 17, wherein the at least one polyuretdione has an average isocyanate content of less than 0.1 weight percent.

27. The one-part thermally curable composition of claim 17, wherein the one-part thermally curable composition is flowable at 20° C.

28. The one-part thermally curable composition of claim 17, wherein said epoxy resin is present.

29. The one-part thermally curable composition of claim 17, wherein said acid stabilizer is present.

30. An adhesive composition comprising a cured reaction product of a one-part thermally curable composition comprising:
at least one polyuretdione, the at least one polyuretdione having an average uretdione ring functionality of at least 1.2, wherein the at least one polyuretdione is a reaction product of components comprising:
a) a uretdione-containing material comprising a reaction product of a diisocyanate reacted with itself,
b) a first hydroxyl-containing compound having a single OH group, wherein the first hydroxyl-containing compound is a primary alcohol or a secondary alcohol; and
c) a second hydroxyl-containing compound having more than one OH group, wherein the second hydroxyl-containing compound is a polyol and the reaction product comprises 0.2 to 0.5, inclusive, of hydroxyl equivalents relative to isocyanate equivalents;
thermally activatable amine curative; and
polythiol having an average sulfhydryl group functionality of at least 2.

31. An assembly comprising the adhesive composition of claim 30 sandwiched between first and second substrates.
